(19) United States
(12) Patent Application Publication
(10) Pub. No.: US 2024/0020545 A1
(43) Pub. Date: Jan. 18, 2024

(54) SELECTING FORECASTING ALGORITHMS USING MOTIFS

(71) Applicant: Verint Americas Inc., Alpharetta, GA (US)

(72) Inventors: Jonathan Silverman, Palo Alto, CA (US); Nicholas Mortimer, Sheffield (GB); Cynthia Freeman, Spokane Valley, WA (US)

(21) Appl. No.: 17/812,312

(22) Filed: Jul. 13, 2022

(51) Int. Cl. G06N 5/02

(52) U.S. Cl. CPC G06N 5/022

(57) ABSTRACT

The present disclosure describes methods and systems for selecting the forecasting algorithm to use for a prediction based on motifs. A motif is a pattern of interval values that is found to repeat in time series data. Time series data that includes historical demand data (e.g., average communication volume) for an entity at various time intervals in the past is received. The time series data is processed to identify motifs. For each identified motif, the forecasting algorithm that best predicts the historical demand data for time intervals associated with the motif is determined. Later, when the entity desires to receive a forecast for a future time interval, the motif associated with the future time interval is determined. The forecasting algorithm determined to best predict demand for the determined motif is then used to predict the demand for the future time interval.

### BACKGROUND

Businesses, or other entities, use forecasting algorithms to make predictions related to demand for products and services at future times. These predictions are used to optimize production or for employee scheduling. For example, an entity such as a call center may use a prediction algorithm to predict the number of communications that will be received at a future time interval. The predicted number of communications can be used to select the number of agents to work at the future time interval.

Currently, there are many forecasting algorithms available for businesses to choose from. Even though a business may train each algorithm to make predictions using its own historical demand data, because of differences in how each algorithm works, each algorithm may have different demand predictions for the same future time interval. Choosing which forecasting algorithm to use for a specific time series can be a difficult task. Furthermore, in many cases one forecasting model may perform well on certain sub patterns within the time series but another forecasting model may perform better on a different sub pattern within the same time series.

### SUMMARY

The present disclosure describes methods and systems for selecting a forecasting algorithm to use for a prediction of a time series, or a portion of a time series, based on motifs. A motif is a pattern of values that is found to repeat in time series data. Time series data in this context includes historical demand data (e.g., average communication volume) for an entity that is received at various time intervals in the past. The time series data is processed to identify motifs. For each identified motif, the forecasting algorithm that best predicts the historical demand data for time intervals associated with the motif is determined. Later, when the entity desires to receive a forecast for a future time interval, the motif associated with the future time interval is determined. The forecasting algorithm determined to best predict demand for the determined motif is then used to predict the demand for the future time interval.

In an embodiment, a method for selecting a forecasting algorithm for a motif is provided. The method includes receiving time series data by a computing device. The time series data includes a plurality of time intervals and each time interval is associated with an interval value. The method includes receiving a plurality of forecasting algorithms by the computing device. The method includes determining a set of motifs from the received time series data by the computing device. Each motif of the set of motifs is associated with a plurality of subsequences of the time series data and each of the plurality of subsequences comprises a time interval of the plurality of time intervals. The method may further include, for each motif of the set of motifs, selecting a forecasting algorithm based on an associated forecast error when predicting the interval value for time intervals from the plurality of subsequences of the time series data associated with the motif by the computing device. The method includes receiving a request to forecast the interval value at a future time interval by the computing device. The method includes determining a motif of the set of motifs that is associated with the future time interval by the computing device. The method includes using the forecasting algorithm selected for the motif to predict the interval value for the future time interval by the computing device. The method includes providing the predicted interval value for the future time interval by the computing device.

Embodiments may include some or all of the following features. Selecting the forecasting algorithm based on the associated forecast error when predicting the interval value for time intervals from the plurality of subsequences of the time series data associated with the motif may include: for each forecasting algorithm of the plurality of forecasting algorithms: training the forecasting algorithm to predict the interval value using a portion of the time series data; and for each time interval in the plurality of subsequences of the time series data that is associated with the motif and is not in the portion: using the forecasting algorithm to predict the interval value for the time interval; determining a difference between the interval value predicted for the time interval and the interval value associated with the time interval in the time series data; and updating the forecast error for the forecasting algorithm using the determined difference; and selecting the forecasting algorithm for the motif based on the forecast error for the forecasting algorithm. The interval value may be one of a communication volume, an average handling time, or a shrinkage. The method may further include one or more of scheduling one or more workers to work during the future time interval based on the predicted interval value and generating a hiring plan for the future time. Selecting the forecasting algorithm based on the associated forecast error may include selecting the forecasting algorithm with a minimum forecast error. Determining the set of motifs may include calculating a matrix profile for the received time series data and determining the set of motifs using the calculated matrix profile. Selecting the forecasting algorithm based on the associated forecast error when predicting the interval value for time intervals from the plurality of subsequences of the time series data associated with the motif may include: for each forecasting algorithm of the plurality of forecasting algorithms: for each subsequence of the plurality of subsequences of the time series data associated with the motif: training the forecasting algorithm to predict the interval value using a portion of the time series data that is before the subsequence in the time series data; and for each time interval in the subsequence: using the forecasting algorithm to predict the interval value for the time interval; determining a difference between the interval value predicted for the time interval and the interval value associated with the time interval in the time series data; and updating the forecast error for the forecasting algorithm using the determined difference; and selecting the forecasting algorithm for the motif based on the forecast error.

In an embodiment, a system is provided. The system includes one or more processors and a memory storing instructions. The instructions when executed by the one or more processors cause the system to: receive time series data, wherein the time series data comprises a plurality of time intervals and each time interval is associated with an interval value; receive a plurality of forecasting algorithms; determine a set of motifs from the received time series data, wherein each motif of the set of motifs is associated with a plurality of subsequences of the time series data, and wherein each of the plurality of subsequences comprises a time interval of the plurality of time intervals; for each motif of the set of motifs, select a forecasting algorithm based on an associated forecast error when predicting the interval value for time intervals from the plurality of subsequences of the time series data associated with the motif; receive a request to forecast the interval value at a future time interval; determine a motif of the set of motifs that is associated with the future time interval; use the forecasting algorithm selected for the motif to predict the interval value for the future time interval; and provide the predicted interval value for the future time interval.

Embodiments may include some or all of the following features. The instructions that when executed by the one or more processors cause the system to select the forecasting algorithm based on the associated forecast error when predicting the interval value for times from the plurality of subsequences of the time series data associated with the motif may further include instructions that when executed by the one or more processors cause the system to: for each forecasting algorithm of the plurality of forecasting algorithms: train the forecasting algorithm to predict the interval value using a portion of the time series data; and for each time interval in the plurality of subsequences of the time series data that is associated with the motif and is not in the portion: use the forecasting algorithm to predict the interval value for the time interval; determine a difference between the interval value predicted for the time interval and the interval value associated with the time interval in the time series data; and update the forecast error for the forecasting algorithm using the determined difference; and select the forecasting algorithm for the motif based on the forecast error. The interval value may be one of a communication volume, an average handling time, or a shrinkage. The instructions may further include instructions that when executed by the one or more processors cause the system to schedule one or more workers to work during the future time interval based on the predicted interval value, or generate a hiring plan for the future time interval. The instructions may further include instructions that when executed by the one or more processors cause the system to select the forecasting algorithm with a minimum forecast error. The instructions may further include instructions that when executed by the one or more processors cause the system to calculate a matrix profile for the received time series data and determine the set of motifs using the calculated matrix profile. The instructions that when executed by the one or more processors cause the system to select the forecasting algorithm based on the associated forecast error when predicting the interval value for time intervals from the plurality of subsequences of the time series data associated with the motif may further include instructions that when executed by the one or more processors cause the system to: for each forecasting algorithm of the plurality of forecasting algorithms: for each subsequence of the plurality of subsequences of the time series data associated with the motif: train the forecasting algorithm to predict the interval value using a portion of the time series data that is before the subsequence in the time series data; and for each time interval in the subsequence: use the forecasting algorithm to predict the interval value for the time interval; determine a difference between the interval value predicted for the time interval and the interval value associated with the time interval in the time series data; and update the forecast error for the forecasting algorithm using the determined difference; and select the forecasting algorithm for the motif based on the forecast error.

In an embodiment, a non-transitory computer-readable medium is provided. The non-transitory computer-readable medium storing instructions that when executed by one or more processors of a system cause the system to: receive time series data, wherein the time series data comprises a plurality of time intervals and each time interval is associated with an interval value; receive a plurality of forecasting algorithms; determine a set of motifs from the received time series data, wherein each motif of the set of motifs is associated with a plurality of subsequences of the time series data, and wherein each of the plurality of subsequences comprises a time interval of the plurality of time intervals; for each motif of the set of motifs, select a forecasting algorithm based on an associated forecast error when predicting the interval value for times from the plurality of subsequences of the time series data associated with the motif; receive a request to forecast the interval value at a future time interval; determine a motif of the set of motifs that is associated with the future time interval; use the forecasting algorithm selected for the motif to predict the interval value for the future time interval; and provide the predicted interval value for the future time interval.

Embodiments may include some or all of the following features. The instructions that when executed by the one or more processors cause the system to select the forecasting algorithm based on the associated forecast error when predicting the interval value for times from the plurality of subsequences of the time series data associated with the motif may further include instructions that when executed by the one or more processors cause the system to: for each forecasting algorithm of the plurality of forecasting algorithms: train the forecasting algorithm to predict the interval value using a portion of the time series data; and for each time in the plurality of subsequences of the time series data that is associated with the motif and is not in the portion: use the forecasting algorithm to predict the interval value for the time interval; determine a difference between the interval value predicted for the time interval and the interval value associated with the time interval in the time series data; and update the forecast error for the forecasting algorithm using the determined difference; and select the forecasting algorithm for the motif based on the forecast error. The instructions further include instructions that when executed by the one or more processors cause the system to calculate a matrix profile for the received time series data and determine the set of motifs using the calculated matrix profile. The instructions that when executed by the one or more processors cause the system to select the forecasting algorithm based on the associated forecast error when predicting the interval value for times from the plurality of subsequences of the time series data associated with the motif further include instructions that when executed by the one or more processors cause the system to: for each forecasting algorithm of the plurality of forecasting algorithms: for each subsequence of the plurality of subsequences of the time series data associated with the motif: train the forecasting algorithm to predict the interval value using a portion of the time series data that is before the subsequence in the time series data; and for each time interval in the subsequence: use the forecasting algorithm to predict the interval value for the time; determine a difference between the interval value predicted for the time interval and the interval value associated with the time interval in the time series data; and update the forecast error for the forecasting algorithm using the determined difference; and select the forecasting algorithm for the motif based on the forecast error. The instructions further include instructions that when executed by the one or more processors cause the one or more processors to schedule one or more workers to work during the future time interval based on the predicted interval value, or generate a hiring plan for the future time interval. The instructions further include instructions that when executed by the one or more processors cause the one or more processors to select the forecasting algorithm with a minimum forecast error.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The foregoing summary, as well as the following detailed description of illustrative embodiments, is better understood when read in conjunction with the appended drawings. For the purpose of illustrating the disclosed embodiments, there is shown in the drawings example constructions of the embodiments; however, the possible embodiments are not limited to the specific methods and instrumentalities disclosed. In the drawings:

FIG. 1 illustrates an example environment for selecting forecasting algorithms based on motifs according to certain embodiments;

FIG. 2 illustrates an example flow diagram of a method for selecting a forecasting algorithm and for generating a forecast for a future time using motifs according to certain embodiments;

FIG. 3 illustrates an example flow diagram of a method for determining a forecasting algorithm for a motif according to certain embodiments;

FIG. 4 illustrates an example flow diagram of a method for determining a forecasting algorithm for a motif according to certain embodiments; and

FIG. 5 is a schematic diagram of a computer system that may be utilized to implement forecasting algorithm selection in accordance with the disclosure according to certain embodiments.

### DETAILED DESCRIPTION

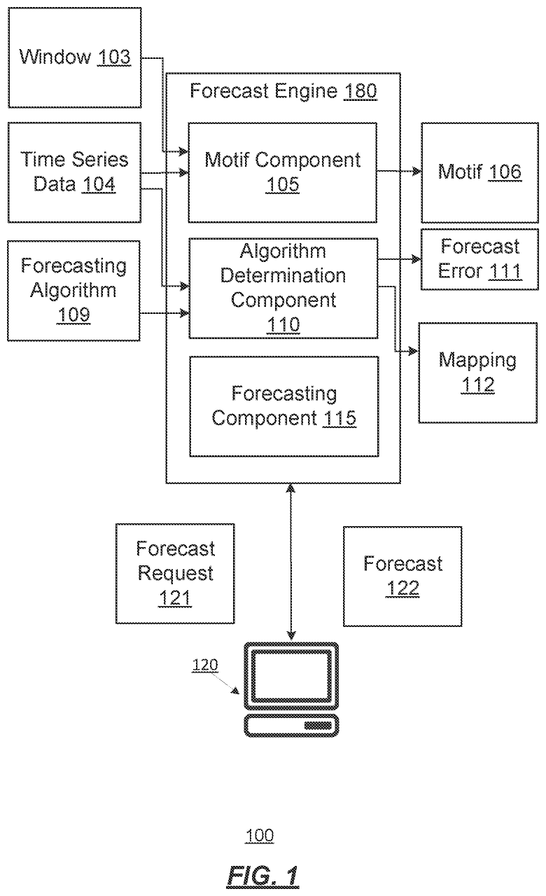

FIG. 1 is an illustration of an example environment 100 for selecting forecasting algorithms 109 based on motifs 106. Entities use forecasting algorithms 109 to predict interval at future time intervals based on values observed at past time intervals. A predicted interval value at a future time interval is known as a forecast 122. For an entity such as a call center that receives and handles communications, the forecast 122 may be a communication volume (e.g., number of calls or messages received) for a future time interval, an average handling time for a future time interval, or for a shrinkage (e.g., total number of agents serving customers divided by total number of unavailable agents) for a predicted time interval. The predicted communication volume or average handling time may be for all communication types or may be for a specific communication type such as e-mail, telephone, or SMS. The predicted communication volume or average handling time may further relate to a particular communication topic or subject such as technical support or billing, for example.

Entities have many forecasting algorithms 109 to choose from. Examples include Autoregressive models (such as ARIMA and SARIMA), Exponential Smoothing, XGBoost, Prophet, Deep Learning, DeepAR, N-Beats, and Temporal Fusion Transformer. Because of differences in how each forecasting algorithm 109 works, each forecasting algorithm 109 may predict a different forecast 122 for a future time, even when trained using the same training data. Because entities rely on forecasts 122 when making future decisions such as planning, scheduling, and hiring, choosing the most accurate forecasting algorithm 109 is important.

Accordingly, to help an entity select a forecasting algorithm 109 to use for a forecast 122, the environment 100 may include a forecast engine 180. The forecast engine 180 may select a forecasting algorithm 109 to use for a forecast 122 based on what are known as motifs 106. A motif 106 is a repeating pattern of similar interval values found in time series data 104. In the case of the environment 100, the time series data 104 may include observed interval values (e.g., communication volumes) for the entity at a series of past consecutive time intervals. A series of consecutive time intervals is referred to herein as a subsequence. In some embodiments, the time series data 104 may include interval values measured at time steps including every hour, every thirty minutes, every fifteen minutes, or every minute. Other time steps may be used.

In a call center, example motifs 106 for an entity may include an observed increase in communication volume for the entity that occurs every Friday between 4 and 6 pm, an observed decrease in communication volume that occurs every Monday between 9 am and 11 am, or an observed increase in communication volume that occurs yearly during the week before Christmas along with an observed decrease in communication volume that occurs between Christmas and New Year's Day. Motifs 106 may repeat daily, weekly, monthly, or even yearly.

In order to select a forecasting algorithm 109 for an entity, the forecast engine 180 may first determine one or more motifs 106 for the entity based on the time series data 104 associated with the entity. The time series data 104 for an entity may be provided by an entity computing device 120. The forecast engine 180 may then determine the forecasting algorithm that 109 performs the best for each motif 106 when predicting interval values of the time series data 104. Later, when the entity sends a forecast request 121 to the forecast engine 180, the forecast engine 180 may determine if the forecast request 121 is for a future time interval that is associated with a motif 106 for the entity. If so, the forecast engine 180 may use the forecasting algorithm 109 that was determined to perform the best for that particular motif 106. The forecast engine 180 is described in further detail below.

Using motifs 106 to select forecasting algorithms 109 is an improvement to any technological field that relies on forecasting. Previously, entities would select a single forecasting algorithm 109 that showed the best performance when predicting interval values across all or most of their historical data (i.e., time series data 104). However, some forecasting algorithms 109, while not having the best overall performance across all of the historical data, may have the best performance for historical data associated with certain motifs 106. According, by considering motifs 106 when selecting a forecasting algorithm 109 for a forecast, the accuracy of the forecasts will be improved which is an improvement to any technological field that relies on forecasting.

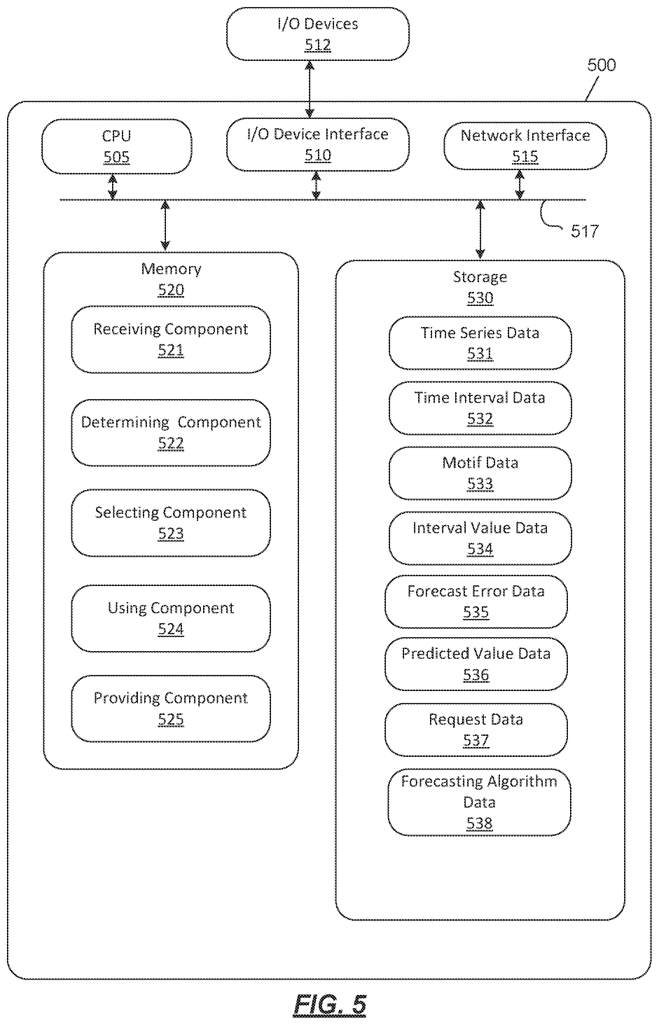

In the example shown, the forecast engine 180 may include several components, including but not limited to, a motif component 105, an algorithm determination component 110, and a forecasting component 115. Each of the components 105, 110, and 115 may be implemented together or separately using one or more computing system such as the computing system 500 illustrated with respect to FIG. 5.

The motif component 105 may determine one or more motifs 106 for entity based on time series data 104. The time series data 104 for an entity may include observed interval values for a plurality of past times. The observed interval values may include communication volume (i.e., how many communications were received during a past time interval), average handling time (i.e., what was the average amount of time that it took to handle a communication during the past time interval), and shrinkage (i.e., what was the percentage of non-productive time per employee or agent that worked at the time interval).

The motif component 105 may determine the motifs 106 for an entity using the time series data 104. In some embodiments, the motif component 105 may determine the motifs 106 for the time series data 104 using the STUMPY software tool. The STUMPY tool takes as an input the time series data 104 and computes a matrix profile for the time series data 104. This matrix profile is then used to determine the motifs 106 for the entity.

In some embodiments, the motif component 105 may take as an input the time series data 104 and a window 103. The window 103 may be the desired size of the determined motifs 106. Example motif 106 size include one hour, one day, several days, or one week. Other motif 106 sizes may be considered.

The motif component 105 may output the motifs 106 determined for an entity. Each motif 106 may identify subsequences of the time series data 104 that are associated with the motif 106. In some embodiments, the motif component 105 may output all of the motifs 106 determined for an entity or may output only the top k motifs 106 determined for an entity. Depending on the embodiment, the motifs 106 may be ranked based on how closely the pattern corresponding to the motif 106 fits each instance of the motif in the time series data 104.

The algorithm determination component 110 may determine the best forecasting algorithm 109 from a set of forecasting algorithms 109 for each motif 106 associated with the entity. In some embodiments, the best forecasting algorithm 109 for a motif 106 is the forecasting algorithm 109 that minimizes a forecast error 111 for the motif 106. How the algorithm determination component computes the forecast error 111 for a motif 106 is described below.

In one embodiment, the algorithm determination component 110 may calculate the forecast error 111 for forecasting algorithm 109 for a motif 106 associated with an entity by first training the forecasting algorithm 109 using a portion of the time series data 104. For example, the portion may be one third or one half of the time series data 104.

After training the forecasting algorithm 109, the algorithm determination component 110 may extract the subsequences associated with the motif 106 from the portion of the time series data 104 not used to train the forecasting algorithm 109. For each time interval in the extracted subsequences, the algorithm determination component 110 may use the forecasting algorithm 109 to predict the interval value for the time interval. The forecasting algorithm 109 may then determine a difference between the predicted interval value and the actual observed interval value for the time interval from the times series data 104. The absolute value of the difference may be used to calculate the forecast error 111 for the forecasting algorithm 109 with respect to the motif 106. The forecast error 111 for a forecast algorithm 109 may be an average difference calculated for each time interval from the subsequences for the motif 106. In some embodiments, the forecast error 111 may be a mean absolute percentage error. Other error calculations may be used.

The algorithm determination component 110 may proceed as described above for each forecasting algorithm 109 and each motif 106. In some embodiments, the algorithm determination component 110 may determine the forecasting algorithm 109 with the smallest or least forecast error 111 for a motif 106 as the forecasting algorithm 109 for the motif 106. In other embodiments, the algorithm determination component 110 may determine the forecasting algorithm 109 from among the forecasting algorithms 109 with the least forecast errors 111 for a motif 106 as the forecasting algorithm 109 for the motif 106. For example, the algorithm determination component 110 may determine the top five or ten forecasting algorithms 109 based on the forecast errors 111, and may determine the forecast algorithm 109 from the top five or top ten forecasting algorithms 109.

In another embodiment, the algorithm determination component 110 may calculate the forecast error 111 for a forecasting algorithm 109 for a motif 106 by first extracting all of the subsequences associated with the motif 106 from the time series data 104. The algorithm determination component 110 may then train the forecasting algorithm 109 using some or all of the time series data 104 up until the first occurring subsequence associated with the motif 106. For each time interval in the first subsequence, the algorithm determination component 110 may use the forecasting algorithm 109 to predict the interval values for the time intervals in the first subsequence. The forecasting algorithm 109 may then determine a difference between the predicted interval values and the actual observed interval values from the time series data 104. The absolute value of the difference may be used to calculate the forecast error 111 for the forecasting algorithm 109 with respect to the motif 106.

The algorithm determination component 110 may then train the forecasting algorithm 109 using some or all of the time series data 104 up until the second occurring subsequence associated with the motif 106. The algorithm determination component 110 may then update the forecast error 111 for the forecasting algorithm 109 using the interval values for the times in the second subsequence as described above. The algorithm determination component 110 may continue training the forecasting algorithm 109 and considering subsequent subsequences until some or all of the subsequences associated with the motif 106 have been considered.

For example, a motif 106 with a window 103 of one week may occur thirty times in the time series data 104. There may be two forecasting algorithms 109, an algorithm A and an algorithm B, under consideration for the first motif 106. The first occurrent of the motif 106 in the time series data 104 may be at a time 19000 where each time step represents one hour.

The algorithm determination component 110 may train the algorithm A using the interval values associated with the time intervals from 1 to 18999 of the time series data 104. The algorithm determination component 110 may then calculate the forecast error 111 for the first occurrence of the motif 106 using time intervals in the subsequence that includes the time intervals 19000 to 19168 because there 168 hours in a week (i.e., the size of the motif 106). The algorithm determination component 110 may repeat the calculation of the forecast error 111 for each occurrence of the motif 106 until the forecast error 111 is calculated for all thirty occurrences of the motifs 106. This process repeated using the algorithm B, and the algorithm with the lowest cumulative forecast error 111 is selected for the motif 106.

After selecting a forecasting algorithm 109 for each motif 106 associated with an entity, the algorithm determination component 110 may generate a mapping 112 for the entity. The mapping 112 may be a mapping from motifs 106 to selected forecasting algorithms 109. Any method for generating a mapping 112 may be used.

The forecasting component 115 may receive a forecast request 121 from the computing device 120 associated with an entity. The forecast request 121 may indicate a future time interval.

In response to the forecast request 121, the forecasting component 115 may retrieve the mapping 112 for the entity. The forecasting component 115 may determine if the future time interval associated with the forecast request 121 is associated with a motif 106 determined for the entity by the motif component 105. For example, the entity may be associated with the motif 106 of increased communication volume between 2 pm and 6 pm on Thursdays. If the future time interval is 3 pm on Thursday, the forecasting component 115 may determine that the future time interval is associated with the motif 106.

If the future time interval is associated with a motif 106, the forecasting component 115 may use the mapping 112 to select the forecasting algorithm 109 with the determined best performance for forecasting values for time intervals associated with the motif 106. Alternatively, if the future time is not associated with a motif 106, then the forecasting component 115 may select a default forecasting algorithm 109. The algorithm determination component 110 may have determined the default forecasting algorithm 109 performed the best for time intervals that were not associated with any of the motifs 106 determined for the entity.

The forecasting component 115 may use the selected forecasting algorithm 109 to predict an interval value for the future time interval associated with the forecast request 121. The interval value may be related to an expected demand at the future time interval such as communication volume. The determined interval value may be provided to the entity computing device 120 as the forecast 122. The entity may then use the forecast 122 for variety of demand-based planning purposes. For example, if the entity is a call center, the entity may use the forecast 122 for the future time to determine a number of agents or workers to schedule during the future time interval to meet a desired level of service or to determine a hiring plan for a future week. Other entities that may use the forecast 122 may include back-office operations (in verticals such as banking and insurance) and retail bank branches. Other types of entities may be supported.

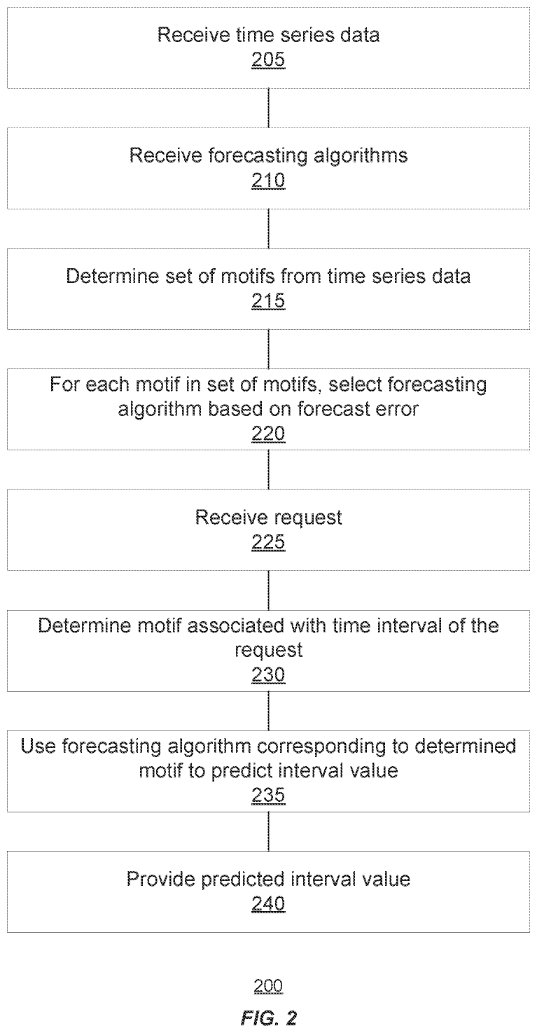

FIG. 2 illustrates an example flow diagram of a method 200 for selecting a forecasting algorithm and for generating a forecast for a future time using motifs according to certain embodiments. The method 200 may be implemented by one or more components of the forecast engine 180.

At block 205, time series data is received by the motif component 105. The motif component 105 of the forecast engine 180 may receive the time series data 104 from an entity computing device 120 associated with an entity. The time series data 104 may include a plurality of interval values and each interval value may be associated with a time interval. The interval values may be the communication volumes observed for the entity at each time interval, average handling times, or shrinkage values. Other interval values may be supported.

At block 210, forecasting algorithms are received by the algorithm determination component 110. In some embodiments, the algorithm determination component 110 may receive the forecasting algorithms 109 from the entity computing device 120 that provided the time series data 104. For example, the entity may have selected the forecasting algorithms 109 for consideration in generating forecasts 122 for the entity using the entity computing device 120.

At block 215, a set of motifs 106 is determined from the time series data 104 by the motif component 105. Each motif may be a repeating pattern of values in the time series data 104. In some embodiments, the motif component 105 may determine the motifs 106 using a matrix profile generated from the time series data 104. Any method for determining motifs 106 in time series data 104 may be used. In some embodiments, each motif 106 may have a size that is based on a window 103 selected by a user or administrator.

At block 220, for each motif in the set of motifs, a forecasting algorithm is selected by the algorithm determination component 110 based on forecast errors 111. The algorithm determination component 110 may select a forecasting algorithm 109 for a motif 106 by, for each forecasting algorithm 109, predicting interval values for the time intervals in the time series data 104 that are associated with the motif 106. The algorithm determination component 110 may then determine differences between the predicted interval values and the actual observed interval values for each time interval. The algorithm determination component 110 may determine the forecast error 111 for the forecasting algorithm 109 using the determined differences. In some embodiments, the algorithm determination component 110 may select the forecasting algorithm 109 with a least forecast error 111 for the motif 106. Alternatively, the algorithm determination component 110 may select the forecasting algorithm 109 from among the forecasting algorithms 109 with the lowest forecast errors 111 (e.g., the five lowest forecasting algorithms 109). The selected forecasting algorithm 109 may be added to a mapping 112 of motifs 106 to forecasting algorithms 109 for the entity associated with the time series data 104.

At block 225, a request is received by the forecasting component 115. The request may be a forecast request 121. The forecast request 121 may be received by the forecasting component 115 from a computing device 120 of the entity associated with the time series data 104. The forecast request 121 may indicate a future time which the entity is requesting a forecast 122 for.

At block 230, a motif associated with the request is determined by the forecasting component 115. The forecasting component 115 may determine the motif associated with the request by determining if the future time interval associated with the forecast request 121 falls within any time intervals associated with a motif 106 of the set of motifs 106.

At block 235, the forecasting algorithm corresponding to the determined motif is used to predict an interval value for the future time interval by the forecasting component 115. The forecasting component 115 may use the forecasting algorithm 109 that was determined for the motif 106 associated with the future time interval. The predicted interval value may be a predicted communication volume for the entity at the predicted time interval, a predicted average handling time, or a predicted shrinkage. If the future time interval was not associated with a motif 106, a default forecasting algorithm 109 may be used to predict the interval value for the future time interval.

At block 240, the predicted interval value is provided by the forecasting component 115. The forecasting component 115 may provide the predicted interval value to the entity computing device 120 as the forecast 122. The entity may then use the forecast 122 for a variety of purposes including determining a number of employees or agents to schedule to work at the future time.

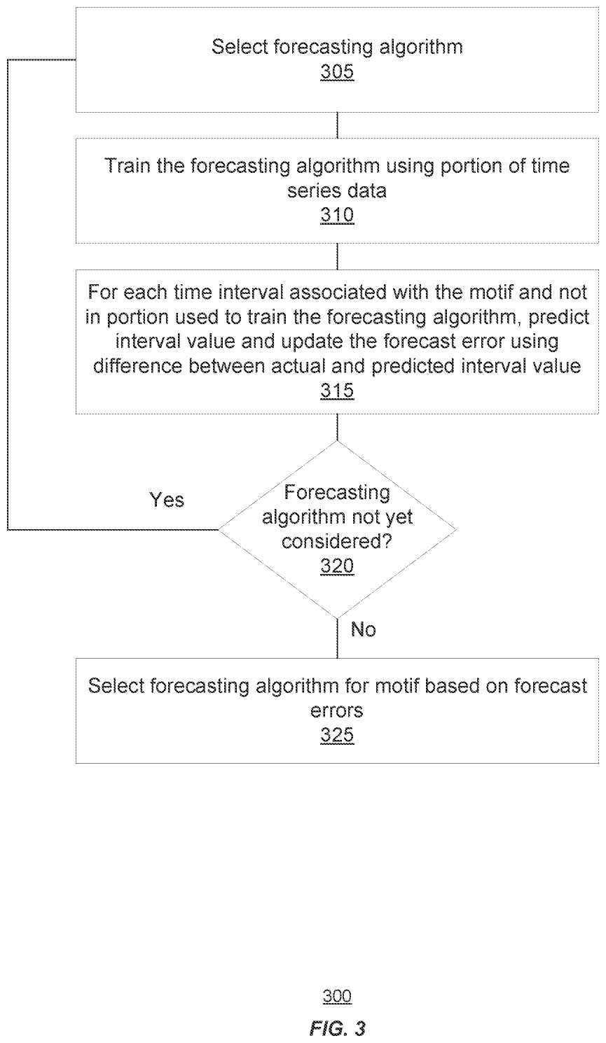

FIG. 3 illustrates an example flow diagram of a method 300 for determining a forecasting algorithm for time intervals associated with a motif according to certain embodiments. The method 300 may be implemented by one or more components of the forecast engine 180.

At block 305, a forecasting algorithm is selected for consideration by the algorithm determination component 110. The algorithm determination component 110 may select the forecasting algorithm 109 from among a plurality of forecasting algorithms 109 that are being considered for use in predicting interval values for time intervals that are associated with a motif 106. The motif 106 may be a pattern of repeating interval values in the time series data 104. The time series data 104 may be historical data for an entity and may include an observed or measured interval value at each time interval of a plurality of time intervals. The measured interval value may be demand related and may include a communication volume, average handling time, or shrinkage. The motif 106 may be associated with subsequences of the plurality of time intervals of the time series data 104.

At block 310, the selected forecasting algorithm is trained using a portion of the time series data by the algorithm determination component 110. The algorithm determination component 110 may train the selected forecasting algorithm 109 using the portion of the time series data 104. In some embodiments, the size of the portion used to train the forecasting algorithm may be a fixed amount of the time series data 104 (e.g., 25%, 35%, or 50%). Alternatively, the portion may include time intervals of the time series data 104 prior to the first occurrence of a subsequence associated with the motif 106. Any method for training a forecasting algorithm 109 may be used.

At block 315, for each time interval associated with a subsequence of the motif and not in the portion used to train the forecasting algorithm, an interval value is predicted for the time interval and the forecast error is updated using a difference between the predicted interval value and an actual interval value for the time by the algorithm determination component 110. The algorithm determination component 110 may predict the interval value for the time interval and may update the forecast error 111 for the forecasting algorithm 109 based on the difference between the predicted interval value and the actual observed interval value. In some embodiments, the forecast error 111 may be an average of the differences between the predicted interval value and the actual observed interval value for each time associated with a subsequence of the time series data 104 that is associated with the motif 106.

At block 320, whether there are any forecasting algorithms that have not yet been considered for the motif is determined by the algorithm determination component 110. If there are no remaining forecasting algorithms 109, then the method 300 may continue at block 325. Else, the method 300 may return to block 305 where the algorithm determination component 110 may select a next forecasting algorithm 109 for consideration for the motif 106.

At block 325, a forecasting algorithm for the motif is selected based on the forecast errors by the algorithm determination component 110. In some embodiments, the algorithm determination component 110 may select the forecasting algorithm 109 with the lowest forecast error 111 and may add it to the mapping 112 for the motif 106. In other embodiments, the algorithm determination component 110 may select from among the forecasting algorithms 109 with the lowest forecast errors 111.

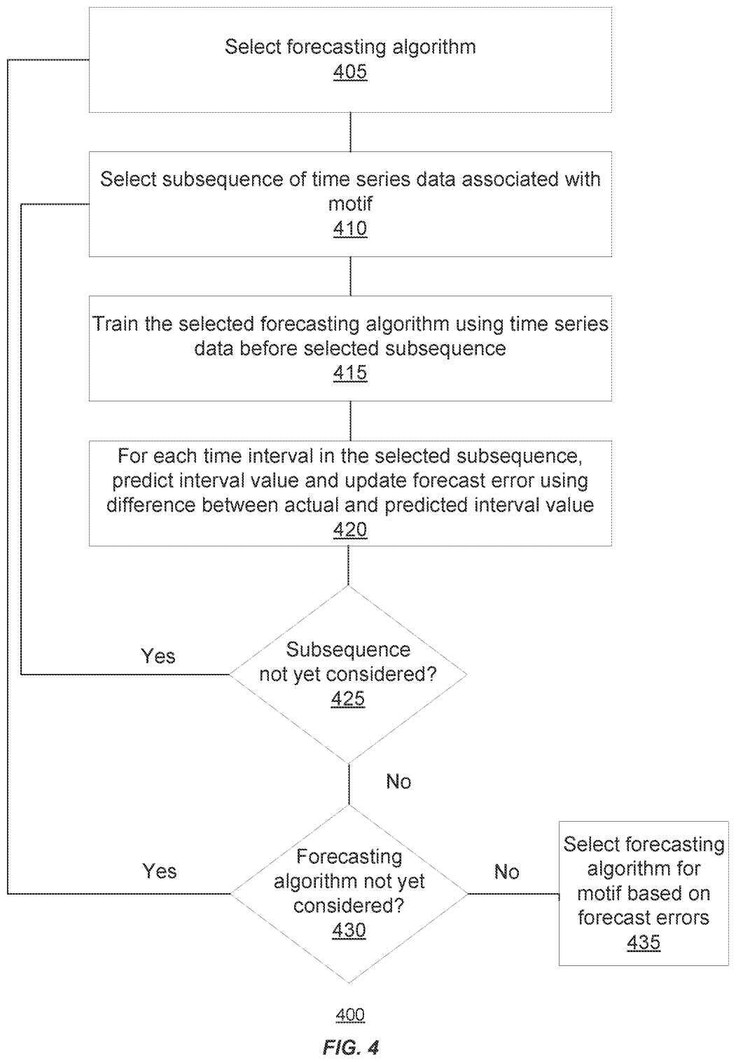

FIG. 4 illustrates an example flow diagram of a method for determining a forecasting algorithm for time intervals associated with a motif according to certain embodiments. The method 400 may be implemented by one or more components of the forecast engine 180.

At block 405, a forecasting algorithm is selected for consideration by the algorithm determination component 110. The algorithm determination component 110 may select the forecasting algorithm 109 from among a plurality of forecasting algorithms 109 that are being considered for use in predicting interval values for time intervals that are associated with a motif 106. The motif 106 may be a pattern of repeating interval values in the time series data 104. The motif 106 may be associated with subsequences of the plurality of time intervals of the time series data 104.

At block 410, a subsequence of the time series data associated with the motif is selected by the algorithm determination component 110. The algorithm determination component 110 may select the subsequence from all of the subsequences associated with the motif 106. The selected subsequence may be the next sequential subsequence of the subsequences associated with the motif 106 in the time series data 104.

At block 415, the selected forecasting algorithm is trained using the time series data 104 by the algorithm determination component 110. The algorithm determination component 110 may train the selected forecasting algorithm 109 using portions of the time series data 104 that are sequentially before the selected subsequence.

At block 420, for each time interval in the selected subsequence of the motif, an interval value is predicted for the time interval and the forecast error is updated using a difference between the predicted interval value and an actual interval value for the time by the algorithm determination component 110. The algorithm determination component 110 may predict the interval value for the time interval and may update the forecast error 111 for the forecasting algorithm 109 based on the difference between the predicted interval value and the actual interval value. In some embodiments, the forecast error 111 may be an average of the difference between the predicted interval value and the actual interval value for each time interval associated with a subsequence of the time series data 104 that is associated with the motif 106.

At block 425, whether any subsequences associated with the motif in the time series data 104 have not been considered is determined by the algorithm determination component 110. If no subsequences remain, then the method 400 may continue at block 430. Else, the method 400 may return to block 410 where a next sequential subsequence of the time series data 104 associated with the motif 106 may be selected for consideration.

At block 430, whether there are any forecasting algorithms that have not yet been considered for the motif is determined by the algorithm determination component 110. If there are no remaining forecasting algorithms 109, then the method 400 may continue at block 435. Else, the method 400 may return to block 405 where the algorithm determination component 110 may select a new forecasting algorithm 109 for consideration for the motif 106.

At block 435, the forecasting algorithm is selected for the motif based on the forecast errors by the algorithm determination component 110. In one embodiment, the algorithm determination component 110 may select the forecasting algorithm 109 with the lowest forecast error 111 and may add it to the mapping 112 for the motif 106. In other embodiments, the algorithm determination component 110 may select from among the forecasting algorithms 109 with the lowest forecast errors 111.

FIG. 5 illustrates examples of computers 500 that may include the kinds of software programs, data stores, and hardware that can implement motif determination and forecasting algorithm selection, as described above according to certain embodiments. As shown, the computing system 500 includes, without limitation, a central processing unit (CPU) 505, a network interface 1315, a memory 520, and storage 530, each connected to a bus 517. The computing system 500 may also include an I/O device interface 510 connecting I/O devices 512 (e.g., keyboard, display and mouse devices) to the computing system 500. Further, the computing elements shown in computing system 500 may correspond to a physical computing system (e.g., a system in a data center) or may be a virtual computing instance executing within a computing cloud.

The CPU 505 retrieves and executes programming instructions stored in the memory 520 as well as stored in the storage 530. The bus 517 is used to transmit programming instructions and application data between the CPU 505, I/O device interface 510, storage 530, network interface 515, and memory 520. Note, CPU 505 is included to be representative of a single CPU, multiple CPUs, a single CPU having multiple processing cores, and the like, and the memory 520 is generally included to be representative of a random access memory. The storage 530 may be a disk drive or flash storage device. Although shown as a single unit, the storage 530 may be a combination of fixed and/or removable storage devices, such as fixed disc drives, removable memory cards, optical storage, network attached storage (NAS), or a storage area-network (SAN).

Illustratively, the memory 520 includes a receiving component 521, a determining component 522, a selecting component 523, a using component 524, and a providing component 525, all of which are discussed in greater detail above. Further, storage 530 includes time series data 531, time interval data 532, motif data 533, interval value data 534, forecast error data 535, predicted value data 536, request data 537, and forecasting algorithm data 538 all of which are also discussed in greater detail above.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although certain implementations may refer to utilizing aspects of the presently disclosed subject matter in the context of one or more stand-alone computer systems, the subject matter is not so limited but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for selecting a forecasting algorithm for a motif comprising:
receiving time series data by a computing device, wherein the time series data comprises a plurality of time intervals and each time interval is associated with an interval value;
receiving a plurality of forecasting algorithms by the computing device;
determining a set of motifs from the received time series data by the computing device, wherein each motif of the set of motifs is associated with a plurality of subsequences of the time series data, and wherein each of the plurality of subsequences comprises a time interval of the plurality of time intervals;
for each motif of the set of motifs, selecting a forecasting algorithm based on an associated forecast error when predicting the interval value for time intervals from the plurality of subsequences of the time series data associated with the motif by the computing device;
receiving a request to forecast the interval value at a future time interval by the computing device;
determining a motif of the set of motifs that is associated with the future time interval by the computing device;
using the forecasting algorithm selected for the motif to predict the interval value for the future time interval by the computing device; and
providing the predicted interval value for the future time interval by the computing device.

2. The method of claim 1, wherein selecting the forecasting algorithm based on the associated forecast error when predicting the interval value for time intervals from the plurality of subsequences of the time series data associated with the motif comprises:
for each forecasting algorithm of the plurality of forecasting algorithms:
training the forecasting algorithm to predict the interval value using a portion of the time series data; and
for each time interval in the plurality of subsequences of the time series data that is associated with the motif and is not in the portion:
using the forecasting algorithm to predict the interval value for the time interval;
determining a difference between the interval value predicted for the time interval and the interval value associated with the time interval in the time series data; and
updating the forecast error for the forecasting algorithm using the determined difference; and
selecting the forecasting algorithm for the motif based on the forecast error for the forecasting algorithm.

3. The method of claim 1, wherein the interval value is one of a communication volume, an average handling time, or a shrinkage.

4. The method of claim 1, further comprising one or more of scheduling one or more workers to work during the future time interval based on the predicted interval value and generating a hiring plan for the future time.

5. The method of claim 1, wherein selecting the forecasting algorithm based on the associated forecast error comprises selecting the forecasting algorithm with a minimum forecast error.

6. The method of claim 1, wherein determining the set of motifs comprises calculating a matrix profile for the received time series data and determining the set of motifs using the calculated matrix profile.

7. The method of claim 1, wherein selecting the forecasting algorithm based on the associated forecast error when predicting the interval value for time intervals from the plurality of subsequences of the time series data associated with the motif comprises:
for each forecasting algorithm of the plurality of forecasting algorithms:
for each subsequence of the plurality of subsequences of the time series data associated with the motif:
training the forecasting algorithm to predict the interval value using a portion of the time series data that is before the subsequence in the time series data; and
for each time interval in the subsequence:
using the forecasting algorithm to predict the interval value for the time interval;
determining a difference between the interval value predicted for the time interval and the interval value associated with the time interval in the time series data; and
updating the forecast error for the forecasting algorithm using the determined difference; and
selecting the forecasting algorithm for the motif based on the forecast error.

8. A system comprising:
one or more processors; and
a memory storing instructions that when executed by the one or more processors cause the system to:
receive time series data, wherein the time series data comprises a plurality of time intervals and each time interval is associated with an interval value;
receive a plurality of forecasting algorithms;
determine a set of motifs from the received time series data, wherein each motif of the set of motifs is associated with a plurality of subsequences of the time series data, and wherein each of the plurality of subsequences comprises a time interval of the plurality of time intervals;
for each motif of the set of motifs, select a forecasting algorithm based on an associated forecast error when predicting the interval value for time intervals from the plurality of subsequences of the time series data associated with the motif;
receive a request to forecast the interval value at a future time interval;
determine a motif of the set of motifs that is associated with the future time interval;
use the forecasting algorithm selected for the motif to predict the interval value for the future time interval; and
provide the predicted interval value for the future time interval.

9. The system of claim 8, wherein the instructions that when executed by the one or more processors cause the system to select the forecasting algorithm based on the associated forecast error when predicting the interval value for times from the plurality of subsequences of the time series data associated with the motif further comprise instructions that when executed by the one or more processors cause the system to:
for each forecasting algorithm of the plurality of forecasting algorithms:
train the forecasting algorithm to predict the interval value using a portion of the time series data; and
for each time interval in the plurality of subsequences of the time series data that is associated with the motif and is not in the portion:
use the forecasting algorithm to predict the interval value for the time interval;
determine a difference between the interval value predicted for the time interval and the interval value associated with the time interval in the time series data; and
update the forecast error for the forecasting algorithm using the determined difference; and
select the forecasting algorithm for the motif based on the forecast error.

10. The system of claim 8, wherein the interval value is one of a communication volume, an average handling time, or a shrinkage.

11. The system of claim 8, further comprising instructions that when executed by the one or more processors cause the system to schedule one or more workers to work during the future time interval based on the predicted interval value, or generate a hiring plan for the future time interval.

12. The system of claim 11, further comprising instructions that when executed by the one or more processors cause the system to select the forecasting algorithm with a minimum forecast error.

13. The system of claim 8, further comprising instructions that when executed by the one or more processors cause the system to calculate a matrix profile for the received time series data and determine the set of motifs using the calculated matrix profile.

14. The system of claim 8, wherein the instructions that when executed by the one or more processors cause the system to select the forecasting algorithm based on the associated forecast error when predicting the interval value for time intervals from the plurality of subsequences of the time series data associated with the motif further comprise instructions that when executed by the one or more processors cause the system to:
for each forecasting algorithm of the plurality of forecasting algorithms:
for each subsequence of the plurality of subsequences of the time series data associated with the motif:
train the forecasting algorithm to predict the interval value using a portion of the time series data that is before the subsequence in the time series data; and
for each time interval in the subsequence:
use the forecasting algorithm to predict the interval value for the time interval;
determine a difference between the interval value predicted for the time interval and the interval value associated with the time interval in the time series data; and
update the forecast error for the forecasting algorithm using the determined difference; and
select the forecasting algorithm for the motif based on the forecast error.

15. A non-transitory computer-readable medium storing instructions that when executed by one or more processors of a system cause the system to:
receive time series data, wherein the time series data comprises a plurality of time intervals and each time interval is associated with an interval value;
receive a plurality of forecasting algorithms;
determine a set of motifs from the received time series data, wherein each motif of the set of motifs is associated with a plurality of subsequences of the time series data, and wherein each of the plurality of subsequences comprises a time interval of the plurality of time intervals;
for each motif of the set of motifs, select a forecasting algorithm based on an associated forecast error when predicting the interval value for times from the plurality of subsequences of the time series data associated with the motif;
receive a request to forecast the interval value at a future time interval;
determine a motif of the set of motifs that is associated with the future time interval;
use the forecasting algorithm selected for the motif to predict the interval value for the future time interval; and
provide the predicted interval value for the future time interval.

16. The non-transitory computer-readable medium of claim 15, wherein the instructions that when executed by the one or more processors cause the system to select the forecasting algorithm based on the associated forecast error when predicting the interval value for times from the plurality of subsequences of the time series data associated with the motif further comprise instructions that when executed by the one or more processors cause the system to:
for each forecasting algorithm of the plurality of forecasting algorithms:
train the forecasting algorithm to predict the interval value using a portion of the time series data; and
for each time in the plurality of subsequences of the time series data that is associated with the motif and is not in the portion:
use the forecasting algorithm to predict the interval value for the time interval;
determine a difference between the interval value predicted for the time interval and the interval value associated with the time interval in the time series data; and
update the forecast error for the forecasting algorithm using the determined difference; and
select the forecasting algorithm for the motif based on the forecast error.

17. The non-transitory computer-readable medium of claim 15, further comprising instructions that when executed by the one or more processors cause the system to calculate a matrix profile for the received time series data and determine the set of motifs using the calculated matrix profile.

18. The non-transitory computer-readable medium of claim 15, wherein the instructions that when executed by the one or more processors cause the system to select the forecasting algorithm based on the associated forecast error when predicting the interval value for times from the plurality of subsequences of the time series data associated with the motif further comprise instructions that when executed by the one or more processors cause the system to:
for each forecasting algorithm of the plurality of forecasting algorithms:
for each subsequence of the plurality of subsequences of the time series data associated with the motif:
train the forecasting algorithm to predict the interval value using a portion of the time series data that is before the subsequence in the time series data; and
for each time interval in the subsequence:
use the forecasting algorithm to predict the interval value for the time;
determine a difference between the interval value predicted for the time interval and the interval value associated with the time interval in the time series data; and
update the forecast error for the forecasting algorithm using the determined difference; and
select the forecasting algorithm for the motif based on the forecast error.

19. The non-transitory computer-readable medium of claim 15, further comprising instructions that when executed by the one or more processors cause the one or more processors to schedule one or more workers to work during the future time interval based on the predicted interval value, or generate a hiring plan for the future time interval.

20. The non-transitory computer-readable medium of claim 15, further comprising instructions that when executed by the one or more processors cause the one or more processors to select the forecasting algorithm with a minimum forecast error.
